(19) United States
(12) Patent Application Publication
(10) Pub. No.: US 2026/0241621 A1
(43) Pub. Date: Aug. 20, 2026

(54) INJECTION-MOLDED BODY, METHOD FOR MANUFACTURING INJECTION-MOLDED BODY, AND DEVICE

(71) Applicant: CANON KABUSHIKI KAISHA, Tokyo (JP)

(72) Inventors: RIEKO USAMI, Kanagawa (JP); YOSHIHITO OSHIMA, Kanagawa (JP); MASATO MAMISHIN, Tokyo (JP)

(21) Appl. No.: 19/639,523

(22) Filed: Apr. 6, 2026

Related U.S. Application Data
(63) Continuation of application No. PCT/JP2024/034967, filed on Sep. 30, 2024.

(30) Foreign Application Priority Data
Oct. 13, 2023 (JP) 2023-177772

(51) Int. Cl. B29C 45/00; B29B 7/00; B29B 13/02; B29K 19/00; B29K 67/00; B29K 105/00

(52) U.S. Cl. CPC B29C 45/0001; B29B 7/002; B29B 13/022; B29C 45/0013; B29K 2019/00; B29K 2067/00; B29K 2105/251

(57) ABSTRACT

An injection-molded body including a matrix resin and a thermoplastic elastomer dispersed in the matrix resin includes a first portion away from a surface of the injection-molded body, and a second portion between the first portion and the surface, and a ratio of the elastomer to the matrix resin in an area range of 10² μm² or more and 130² μm² or less in the second portion is 1.3 times or more a ratio of the elastomer to the matrix resin in an area range of 10² μm² or more and 130² μm² or less in the first portion.

### CROSS-REFERENCE TO RELATED APPLICATIONS

This application is a Continuation of International Patent Application No. PCT/JP2024/034967, filed Sep. 30, 2024, which claims the benefit of Japanese Patent Application No. 2023-177772, filed Oct. 13, 2023, both of which are hereby incorporated by reference herein in their entirety.

### BACKGROUND

### Field of the Technology

The present disclosure relates to an injection-molded body, a method for manufacturing an injection-molded body, and a device.

### Description of the Related Art

It is known that a resin composition obtained by adding a thermoplastic elastomer to a resin improves mechanical properties such as impact strength. Further, as illustrated in Japanese Patent Laid-Open No. 2011-231165, the compatibility between a resin and an elastomer is increased by adding a compatibilizing agent. This prevents interface detachment caused in a simple blend system of the resin and the elastomer and improves impact strength.

However, the addition of an elastomer and a compatibilizing agent to a resin significantly decreases the flexural modulus of the resin composition, and therefore, many issues still remain in order to achieve mechanical properties such as flexural modulus, impact strength, and the like together. In the resin composition described in Japanese Patent Laid-Open No. 2011-231165, there is room for improvement in mechanical properties, particularly flexural modulus. Accordingly, an aspect of the present embodiment is directed to providing an injection-molded body having excellent mechanical properties.

### SUMMARY

An injection-molded body including a matrix resin and a thermoplastic elastomer dispersed in the matrix resin according to the present disclosure includes a first portion away from a surface of the injection-molded body, and a second portion between the first portion and the surface, wherein a ratio of the elastomer to the matrix resin in an area range of 10² μm² or more and 130² μm² or less in the second portion is 1.3 times or more a ratio of the elastomer to the matrix resin in an area range of 10² μm² or more and 130² μm² or less in the first portion.

Features of the present disclosure will become apparent from the following description of embodiments with reference to the attached drawings.

### BRIEF DESCRIPTION OF THE DRAWINGS

FIG. 1 is a conceptual diagram illustrating an example of an injection-molded body according to the present embodiment.

FIG. 2A is a cross-sectional scanning electron microscope (SEM) image of an injection-molded body according to example 1.

FIG. 2B is a cross-sectional scanning electron microscope (SEM) image of an injection-molded body according to example 1.

FIG. 3 is a schematic diagram illustrating a device according to the present embodiment.

### DESCRIPTION OF THE EMBODIMENTS

Embodiments for carrying out the present disclosure will be described in detail below. The following embodiments for carrying out the present disclosure are illustrative for describing the present disclosure, and the present disclosure is not limited to the following content.

### <<Injection-Molded Body>>

An injection-molded body according to the present embodiment is an injection-molded body including a matrix resin and a thermoplastic elastomer dispersed in the matrix resin.

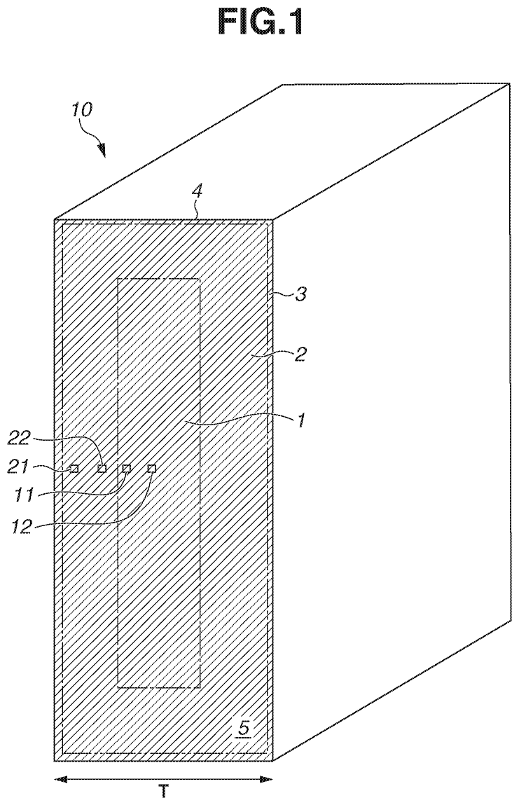

FIG. 1 illustrates a conceptual diagram illustrating an example of an injection-molded body 10 according to the present embodiment. A cross-section 5 of the injection-molded body 10, which is indicated by hatching in FIG. 1, is a transverse cross-section of a central portion of the tabular injection-molded body 10. However, the shape of the injection-molded body 10 and the position and the shape of the cross-section are not particularly limited. For example, a thickness T of the injection-molded body 10 according to the present embodiment may be in the range of 1 mm to 5 mm, but is not limited to this. The dimension of the injection-molded body 10 in a direction perpendicular to the thickness direction may be greater than the thickness T, and for example, may be in the range of 10 mm to 1000 mm, but is not limited to this.

The injection-molded body 10 illustrated in FIG. 1 includes a first portion 1 away from a surface 4 of the injection-molded body 10, and a second portion 2 between the first portion 1 and the surface 4. Although the first portion 1 and the second portion 2 can be observed in the cross-section 5 of the injection-molded body 10, the injection-molded body 10 includes the first portion 1 and the second portion 2 without having to cut the injection-molded body 10. The ratio of the elastomer to the matrix resin in area ranges 21 and 22 of 10² μm² or more and 130² μm² or less in the second portion is 1.3 times or more the ratio of the elastomer to the matrix resin in area ranges 11 and 12 of 10² μm² or more and 130² μm² or less in the first portion 1. It is desirable that the ratio of the elastomer to the matrix resin in the area ranges 21 and 22 be 1.5 times or more the ratio of the elastomer to the matrix resin in the area ranges 11 and 12. As described above, the first portion 1 and the second portion 2 are defined by the relationship between the ratios of the elastomer to the matrix resin. Thus, the first portion 1, which is a portion where the ratio of the elastomer to the matrix resin is relatively low, can be referred to as a “low ratio portion”. The second portion 2, which is a portion where the ratio of the elastomer to the matrix resin is relatively high, can be referred to as a “high ratio portion”.

Further, as illustrated in FIG. 1, the injection-molded body 10 according to the present embodiment may include a third portion 3 between the second portion 2 and the surface 4. The third portion 3 can constitute the surface 4. It is desirable that the ratio of the elastomer to the matrix resin in an area range of 10² μm² or more and 130² μm² or less in the third portion 3 be lower than the ratio of the elastomer to the matrix resin in the area ranges of 10² μm² or more and 130² μm² or less in the first portion 1. Thus, the third portion 3, which is a portion where the ratio of the elastomer to the matrix resin is relatively low compared to that in the first portion as the low ratio portion, can be referred to as a “super-low ratio portion”.

Hereinafter, “the ratio of the elastomer to the matrix resin in an area range of 10² μm² or more and 130² μm² or less in an n-th portion” (n is an integer from 1 to 3) is occasionally referred to simply as “the elastomer ratio in the n-th portion”. A fourth portion (not illustrated) where the ratio of the elastomer to the matrix resin is higher than the elastomer ratio in the first portion 1 and lower than the elastomer ratio in the second portion 2 can be present between the first portion 1 and the second portion 2. The fourth portion can be referred to as a “medium ratio portion”. The ratio of the elastomer to the matrix resin in the medium ratio portion can be more than 1.0 times and less than 1.3 times the ratio of the elastomer to the matrix resin in the first portion 1 (the low ratio portion).

The first portion 1 is a portion further away inside from the surface 4 than the second portion 2 and the third portion 3 in a case where a surface that comes into contact with a mold in injection molding is defined as the surface 4. FIG. 1 illustrates a range where the first portion 1 (the low ratio portion) is suitably present, as a region surrounded by a boundary indicated by a one-dot chain line (an inside chain line). For example, the first portion 1 can be present in a region 250 μm or more, typically 500 μm or more, away inside from the surface 4. That is, the distance between the boundary indicated by the one-dot chain line and the surface 4 indicated by a solid line in FIG. 1 can be 250 μm or more or 500 μm or more. This means that the first portion 1 can be present in the region 250 μm or more or 500 μm or more away inside from the surface 4, and not the entirety of the region 250 μm or more or 500 μm or more away inside from the surface 4 needs to be the first portion 1. The first portion 1 can be present in a region 250 μm or more or 500 μm or more away from both two surfaces (a front surface and a back surface) opposed to each other in the thickness direction in the surface 4. The distance between the two surfaces is the thickness T, and therefore, for example, the first portion 1 can be present in a region 250 μm or more or 500 μm or more away inside from the surface 4 and T−250 μm or less or T/2 or less away inside from the surface 4. Considering that the typical thickness T is 1 mm or more, the first portion 1 can be present in a region 250 μm or more or 500 μm or more away and 750 μm or less or 600 μm or less away from one surface in the surface 4. The elastomer ratio in the first portion 1 is smaller than the elastomer ratio in the second portion 2. It is desirable that the elastomer ratio in the first portion 1 be greater than the elastomer ratio in the third portion 3. For example, the elastomer ratio in the first portion 1 can be measured in a region 250 μm or more or 500 μm or more away inside from the surface 4 and T−250 μm or less, T/2 or less, and 750 μm or less or 600 μm or less away inside from the surface 4. It is desirable that the elastomer ratio in the first portion 1 be the average value of the plurality of area ranges 11 and 12, each having an area of 10² μm² or more and 130² μm² or less, in the first portion 1. For example, the elastomer ratio in the first portion 1 is less than 50%. It is desirable that the elastomer ratio in the first portion 1 be 25% or less. It is more desirable that the elastomer ratio in the first portion 1 be 15% or less. For example, the elastomer ratio in the first portion 1 is 5% or more. It is desirable that the elastomer ratio in the first portion 1 be 10% or more.

The second portion 2 is a portion further away inside from the surface 4 than the third portion 3. FIG. 1 illustrates a range where the second portion 2 (the high ratio portion) is suitably present, as a region sandwiched between the boundary indicated by the one-dot chain line and a boundary indicated by a two-dot chain line (an outside chain line). For example, the second portion 2 can be present in a region 50 μm or more away inside from the surface 4 and less than 500 μm or less than 250 μm away inside from the surface 4. That is, the distance between the boundary indicated by the two-dot chain line and the surface 4 indicated by the solid line in FIG. 1 can be 50 μm or more. The distance between the boundary indicated by the one-dot chain line and the surface 4 indicated by the solid line in FIG. 1 can be less than 500 μm or less than 250 μm. This means that the second portion 2 can be present in the region 50 μm or more away inside from the surface 4 and less than 500 μm or less than 250 μm away inside from the surface 4, and not the entirety of the region 50 μm or more away inside from the surface 4 and less than 500 μm or less than 250 μm away inside from the surface 4 needs to be the second portion 2. In a region 250 μm or more and less than 500 μm away inside from the surface 4, the first portion 1 may be present, or the second portion 2 may be present. The elastomer ratio in the second portion 2 is 1.3 times or more the elastomer ratio in the first portion 1. The elastomer ratio in the second portion 2 is greater than the elastomer ratio in the third portion 3. It is desirable that the elastomer ratio in the second portion 2 be the maximum value of the plurality of area ranges 21 and 22, each having an area of 10² μm² or more and 130² μm² or less, in the second portion 2. For example, the elastomer ratio in the second portion 2 is 10% or more. It is desirable that the elastomer ratio in the second portion 2 be 15% or more. It is more desirable that the elastomer ratio in the second portion 2 be 25% or more. For example, the elastomer ratio in the second portion 2 is less than 50%. It is desirable that the elastomer ratio in the second portion 2 be 40% or less.

The third portion 3 is a portion between the second portion 2 and the surface 4 and may include the surface 4. FIG. 1 illustrates a range where the third portion 3 (the super-low ratio portion) is suitably present, as a region sandwiched between the boundary indicated by the two-dot chain line and the surface 4 indicated by the solid line. For example, the third portion 3 can be present in a region less than 50 μm away inside from the surface 4. That is, the distance between the boundary indicated by the two-dot chain line and the surface 4 indicated by the solid line in FIG. 1 can be less than 50 μm. This means that the third portion 3 can be present in the region less than 50 μm away inside from the surface 4, and not the entirety of the region less than 50 μm away inside from the surface 4 needs to be the third portion 3. The third portion 3 is a portion immediately cooled and solidified by a resin composition coming into contact with a metal mold. Thus, if the melting point or the glass-transition point of the matrix resin is the highest among the materials constituting the resin composition, the matrix resin is present at a higher ratio than that of the entirety of the resin composition and is hard.

It is desirable that in the first portion 1 and the second portion 2, the matrix resin and the elastomer material form a phase separation structure, and elastomer particles be dispersed in the matrix resin. When an impact is given to the molded body, the dispersed elastomer particles form crazes and absorb the impact, whereby it is possible to exhibit high impact strength. Due to the formation of the phase separation structure, the hardness of the matrix resin is higher than that of the matrix resin with which the elastomer material is compatibilized. This prevents a decrease in the flexural modulus. It is desirable that the average particle diameter of the elastomer particles in the second portion 2 be larger than the average particle diameter of the elastomer particles in the first portion 1. For example, the average particle diameter of the elastomer particles in the first portion 1 is 1.0 μm or less. It is desirable that the average particle diameter of the elastomer particles in the first portion 1 be 0.9 μm or less. It is more desirable that the average particle diameter of the elastomer particles in the first portion 1 be 0.8 μm or less. For example, the average particle diameter of the elastomer particles in the first portion 1 is 0.1 μm or more. For example, the average particle diameter of the elastomer particles in the second portion 2 is greater than 1.0 μm. It is desirable that the average particle diameter of the elastomer particles in the second portion 2 be 1.2 μm or more. It is more desirable that the average particle diameter of the elastomer particles in the second portion 2 be 1.5 μm or more. For example, the average particle diameter of the elastomer particles in the second portion 2 is 5 μm or less. For example, the difference between the average particle diameter of the elastomer particles in the first portion 1 and the average particle diameter of the elastomer particles in the second portion 2 is 0.8 μm or more. It is desirable that the difference between the average particle diameter of the elastomer particles in the first portion 1 and the average particle diameter of the elastomer particles in the second portion 2 be 1.0 μm or more. It is more desirable that the difference between the average particle diameter of the elastomer particles in the first portion 1 and the average particle diameter of the elastomer particles in the second portion 2 be 1.2 μm or more. For example, the average particle diameter of the elastomer particles in the second portion 2 is twice or more the average particle diameter of the elastomer particles in the first portion 1. It is desirable that the average particle diameter of the elastomer particles in the second portion 2 be 3 times or more the average particle diameter of the elastomer particles in the first portion 1. For example, the average particle diameter of the elastomer particles in the second portion 2 is 20 times or less the average particle diameter of the elastomer particles in the first portion 1. It is desirable that the average particle diameter of the elastomer particles in the second portion 2 be 10 times or less the average particle diameter of the elastomer particles in the first portion 1. The average particle diameter of the elastomer particles in the second portion 2 may be 5 times or less the average particle diameter of the elastomer particles in the first portion 1.

The second portion 2 has flexibility due to the highness of the elastomer ratio. The second portion 2 having flexibility is present at a position close to the surface 4, whereby it is possible to prevent the development of cracks generated when an impact is given to the third portion 3 having hardness if the ratio of the matrix resin is high, and it is possible to soften the impact more effectively. Thus, it is possible to provide high impact strength to the injection-molded body. To control the elastomer ratio, it is desirable to adjust the relative size relationship between the average particle diameters of the elastomer particles as described above, but the present disclosure is not limited to this. For example, even if the average particle diameter of the elastomer particles in the second portion 2 is not larger than the average particle diameter of the elastomer particles in the first portion 1, it is also possible to adjust the elastomer ratio by adjusting the number (the number density) of the elastomer particles in the second portion 2 and the number (the number density) of the elastomer particles in the first portion 1.

The injection-molded body according to the present embodiment has a structure as described above and thereby can obtain excellent mechanical properties such as excellent flexural modulus, excellent impact strength, and the like. Although in the above description, the average particle diameter has been used as the representative particle diameter of the elastomer particles, the median particle diameter (the median diameter) or the modal particle diameter may be used instead of the average particle diameter. The value described as the average particle diameter can also be read as the value of the median particle diameter or the modal particle diameter.

### <<Method for Manufacturing Injection-Molded Body>>

### <Resin Composition>

First, a description is given of a resin composition that can be used to manufacture the injection-molded body according to the present disclosure. The resin composition according to the present embodiment includes a resin as a matrix and a thermoplastic elastomer material. Further, filler particles may be added to improve mechanical properties. Further, additives and the like required to add other functions may be added.

### [Matrix Resin]

As the matrix resin, a thermoplastic resin that can be injection-molded is used. It is desirable to use a polar polymer as the matrix resin among thermoplastic resins. For example, the polar polymer refers to a polymer including a polar group such as an amide group, an imide group, a carbonyl group (a ketone group), an ester bond, or the like as a main chain. The polar polymer is a resin generally termed a general-purpose engineering plastic or a super engineering plastic and is used for an application requiring higher physical properties in heat resistance, strength, and the like than a general-purpose resin such as polyethylene or polypropylene. If it is possible to improve mechanical and physical property values, it is possible to make a molded product thin and light. Thus, further improvements in the physical properties are expected.

Specific examples of the polar polymer as the polymer including the amide group include polyamide, polyamide-imide, and the like. Examples of the polar polymer as the polymer including the imide group include polyimide, polyamide-imide, polyetherimide, and the like. Examples of the polar polymer as the polymer including the carbonyl group (the ketone group) include polyetherketone, polyether ether ketone, and the like. Examples of the polar polymer as the polymer including the ester bond include polyarylate, polycarbonate, polyester, and the like. Examples of the polyester include polyethylene terephthalate, polybutylene terephthalate, polyethylene naphthalate, polybutylene naphthalate, and the like.

It is desirable to use a crystalline polymer as the matrix resin among thermoplastic resins. The crystalline polymer is advantageous in that the crystalline polymer is excellent in hardness, elasticity, and stiffness compared to a non-crystalline polymer. Among the above polar polymers, examples of the crystalline polymer include polyamide, polyetherketone, polyether ether ketone, polyethylene terephthalate, polybutylene terephthalate, polyethylene naphthalate, polybutylene naphthalate, and the like. Among polyesters, polyarylate and polycarbonate are non-crystalline polymers. Other examples of the crystalline polymer include polyacetal and the like. As the matrix resin, polyester is desirable, and polyethylene terephthalate is more desirable. Polyethylene terephthalate is excellent in recyclability, and additionally, the CO₂ emission in the production of polyethylene terephthalate is smaller than the CO₂ emission in the production of polycarbonate. Thus, the use of polyethylene terephthalate can contribute to reducing CO₂ emissions. For example, the crystallinity of the matrix or the crystalline polymer is 1% to 50%. It is desirable that the crystallinity of the matrix or the crystalline polymer be 1% to 40%. It is possible to control the crystallinity according to molding conditions (temperature and pressure).

Alternatively, the matrix resin may be a polar polymer cross-linked using a cross-linking agent. Examples of the cross-linking agent include compounds that perform a cross-link reaction by heat, such as a carbodiimide cross-linking agent, an oxazoline cross-linking agent, an epoxy cross-linking agent, an isocyanate cross-linking agent, and the like. For example, the polar polymer may be a recycled polymer obtained by collecting a used polymer having a decreased molecular weight, re-cross-linking the used polymer using the cross-linking agent, and increasing the molecular weight. As the used polymer and the recycled polymer, polyethylene terephthalate, which is produced and used in large amounts, is suitable.

The carbodiimide cross-linking agent according to the present embodiment refers to a compound including at least one carbodiimide group in a molecule, and for example, can be manufactured by a decarboxylation reaction caused by heating an organic isocyanate in the presence of an appropriate catalyst. The carbodiimide group is represented as (—N═C═N—). In the resin matrix using the carbodiimide cross-linking agent, a carbodiimide group derived from the carbodiimide cross-linking agent is present as a part of a macromolecule.

Examples of the carbodiimide cross-linking agent include mono- or dicarbodiimide compounds such as diphenylcarbodiimide, dicyclohexylcarbodiimide, di-2,6-dimethylphenylcarbodiimide, diisopropylcarbodiimide, dioctyldecylcarbodiimide, di-o-toluylcarbodiimide, di-p-toluylcarbodiimide, di-p-nitrophenylcarbodiimide, di-p-aminophenylcarbodiimide, di-p-hydroxyphenylcarbodiimide, di-p-chlorophenylcarbodiimide, di-o-chlorophenylcarbodiimide, di-3,4-dichlorophenylcarbodiimide, di-2,5-dichlorophenylcarbodiimide, p-phenylene-bis-o-toluylcarbodiimide, p-phenylene-bis-dicyclohexylcarbodiimide, p-phenylene-bis-di-p-chlorophenylcarbodiimide, 2,6,2′,6′-tetraisopropyldiphenylcarbodiimide, hexamethylene-bis-cyclohexylcarbodiimide, ethylene-bis-diphenylcarbodiimide, ethylene-bis-di-cyclohexylcarbodiimide, N,N′-di-o-tolylcarbodiimide, N,N′-diphenylcarbodiimide, N,N′-dioctyldecylcarbodiimide, N,N′-di-2,6-dimethylphenylcarbodiimide, N-tolyl-N′-cyclohexylcarbodiimide, N,N′-di-2,6-diisopropylphenylcarbodiimide, N,N′-di-2,6-di-tert-butylphenylcarbodiimide, N-toluyl-N′-phenylcarbodiimide, N,N′-di-p-nitrophenylcarbodiimide, N,N′-di-p-aminophenylcarbodiimide, N,N′-di-p-hydroxyphenylcarbodiimide, N,N′-di-cyclohexylcarbodiimide, N,N′-di-p-toluylcarbodiimide, N,N′-benzylcarbodiimide, N-octadecyl-N′-phenylcarbodiimide, N-benzyl-N′-phenylcarbodiimide, N-octadecyl-N′-tolylcarbodiimide, N-cyclohexyl-N′-tolylcarbodiimide, N-phenyl-N′-tolylcarbodiimide, N-benzyl-N′-tolylcarbodiimide, N,N′-di-o-ethylphenylcarbodiimide, N,N′-di-p-ethylphenylcarbodiimide, N,N′-di-o-isopropylphenylcarbodiimide, N,N′-di-p-isopropylphenylcarbodiimide, N,N′-di-o-isobutylphenylcarbodiimide, N,N′-di-p-isobutylphenylcarbodiimide, N,N′-di-2,6-diethylphenylcarbodiimide, N,N′-di-2-ethyl-6-isopropylphenylcarbodiimide, N,N′-di-2-isobutyl-6-isopropylphenylcarbodiimide, N,N′-di-2,4,6-trimethylphenylcarbodiimide, N,N′-di-2,4,6-triisopropylphenylcarbodiimide, N,N′-di-2,4,6-triisobutylphenylcarbodiimide, and the like; polycarbodiimides such as poly(1,6-hexamethylenecarbodiimide), poly(4,4′-methylenebiscyclohexylcarbodiimide), poly(1,3-cyclohexylenecarbodiimide), poly(1,4-cyclohexylenecarbodiimide), poly(4,4′-diphenylmethanecarbodiimide), poly(3,3′-dimethyl-4,4′-diphenylmethanecarbodiimide), poly(naphthylenecarbodiimide), poly(p-phenylenecarbodiimide), poly(m-phenylenecarbodiimide), poly(tolylcarbodiimide), poly(diisopropylcarbodiimide), poly(methyl-diisopropylphenylenecarbodiimide), poly(triethylphenylenecarbodiimide), poly(triisopropylphenylenecarbodiimide), and the like; and the like.

The oxazoline cross-linking agent according to the present embodiment refers to a compound including an oxazoline group in a molecule. Particularly, a polymer synthesized using a monomer including an oxazoline compound as at least one of the raw material monomers of the polymer is desirable. Examples of the oxazoline compound include 2-oxazoline, 3-oxazoline, and 4-oxazoline compounds, and any of these may be used. Particularly, the 2-oxazoline compound is rich in reactivity and also industrially put to practical use. Examples of the oxazoline compound include 2-vinyl-2-oxazoline, 5-methyl-2-vinyl-2-oxazoline, 4,4-oxazoline, 4,4-dimethyl-2-vinyl-5,6-dihydro-4H-1,-oxazine, 4,4,6-trimethyl-2-vinyl-5,6-dihydro-4H-1,3-oxazine, 2-isopropenyl-2-oxazoline, 4,4-dimethyl-2-isopropenyl-2-oxazoline, 4-acryloyl-oxymethyl-2,4-dimethyl-2-oxazoline, 4-methacryloyl-oxymethyl-2,4-dimethyl-2-oxazoline, 4-methacryloyl-oxymethyl-2-phenyl-4-methyl-2-oxazoline, 2-(4-vinylphenyl)-4,4-dimethyl-2-oxazoline, 4-ethyl-4-hydroxymethyl-2-isopropenyl-2-oxazoline, 4-ethyl-4-carboethoxymethyl-2-isopropenyl-2-oxazoline, and the like. The present disclosure, however, is not limited to these.

As the epoxy cross-linking agent according to the present embodiment, for example, a glycidyl ether compound, a glycidyl ester compound, a glycidyl amine compound, a glycidyl imide compound, an alicyclic epoxy compound, or the like can be desirably used.

Examples of the glycidyl ether compound can include bisphenol A diglycidyl ether type epoxy resins, bisphenol F diglycidyl ether type epoxy resins, bisphenol S diglycidyl ether type epoxy resins, and the like obtained by condensation reactions between bisphenols such as butyl glycidyl ether, stearyl glycidyl ether, allyl glycidyl ether, phenyl glycidyl ether, o-phenyl phenyl glycidyl ether, ethylene oxide lauryl alcohol glycidyl ether, ethylene oxide phenol glycidyl ether, ethylene glycol diglycidyl ether, polyethylene glycol diglycidyl ether, propylene glycol diglycidyl ether, polypropylene glycol diglycidyl ether, neopentyl glycol diglycidyl ether, polytetramethylene glycol diglycidyl ether, cyclohexane dimethanol diglycidyl ether, glycerol triglycidyl ether, trimethylol propane triglycidyl ether, pentaerythritol polyglycidyl ether, 2,2-bis-(4-hydroxyphenyl) propane, 2,2-bis-(4-hydroxyphenyl) methane, bis(4-hydroxyphenyl) sulfone, and the like, and epichlorohydrin. Among these, the bisphenol A diglycidyl ether type epoxy resins are desirable.

Examples of the glycidyl ester compound can include benzoic acid glycidyl ester, p-toluic acid glycidyl ester, cyclohexane carboxylic acid glycidyl ester, stearic acid glycidyl ester, lauric acid glycidyl ester, palmitic acid glycidyl ester, versatic acid glycidyl ester, oleic acid glycidyl ester, linoleic acid glycidyl ester, linolenic acid glycidyl ester, terephthalic acid diglycidyl ester, isophthalic acid diglycidyl ester, phthalic acid diglycidyl ester, naphthalene dicarboxylic acid diglycidyl ester, vinyl benzoic acid diglycidyl ester, methylterephthalic acid diglycidyl ester, hexahydrophthalic acid diglycidyl ester, tetrahydrophthalic acid diglycidyl ester, cyclohexane dicarboxylic acid diglycidyl ester, adipic acid diglycidyl ester, succinic acid diglycidyl ester, sebacic acid diglycidyl ester, dodecanedioic acid diglycidyl ester, octadecanedioic acid diglycidyl ester, trimellitic acid triglycidyl ester, pyromellitic acid tetraglycidyl ester, and the like. Among these, benzoic acid glycidyl ester and versatic acid glycidyl ester are desirable.

Examples of the glycidyl amine compound can include tetraglycidylaminodiphenylmethane, triglycidyl-para-aminophenol, triglycidyl-meta-aminophenol, diglycidyl aniline, diglycidyl toluidine, tetraglycidyl-meta-xylenediamine, diglycidyl tribromoaniline, tetraglycidylbis(aminomethyl)cyclohexane, triglycidyl cyanurate, triglycidyl isocyanurate, and the like. Examples of the glycidyl imide compound can include N-glycidylphthalimide, N-glycidyl-4-methylphthalimide, N-glycidyl-4,5-dimethylphthalimide, N-glycidyl-3-methylphthalimide, N-glycidyl-3,6-dimethylphthalimide, N-glycidyl-4-ethoxyphthalimide, N-glycidyl-4-chlorophthalimide, N-glycidyl-4,5-dichlorophthalimide, N-glycidyl-3,4,5,6-tetrabromophthalimide, N-glycidyl-4-n-butyl-5-bromophthalimide, N-glycidylsuccinimide, N-glycidylhexahydrophthalimide, N-glycidyl-1,2,3,6-tetrahydrophthalimide, N-glycidylmaleimide, N-glycidyl-α,β-dimethylsuccinimide, N-glycidyl-a-ethylsuccinimide, N-glycidyl-α-propylsuccinimide, N-glycidylbenzamide, N-glycidyl-p-methylbenzamide, N-glycidylnaphthamide, N-glycidyl stearamide, and the like. Among these, N-glycidylphthalimide is desirable.

Examples of the alicyclic epoxy compound can include 3,4-epoxycyclohexylmethyl-3,4-epoxycyclohexylcarboxylate, bis(3,4-epoxycyclohexylmethyl) adipate, vinylcyclohexenediepoxide, N-methyl-4,5-epoxycyclohexane-1,2-dicarboxylic acid imide, N-ethyl-4,5-epoxycyclohexane-1,2-dicarboxylic acid imide, N-phenyl-4,5-epoxycyclohexane-1,2-dicarboxylic acid imide, N-naphthyl-4,5-epoxycyclohexane-1,2-dicarboxylic acid imide, N-tolyl-3-methyl-4,5-epoxycyclohexane-1,2-dicarboxylic acid imide, and the like.

As another epoxy compound, an epoxy-modified fatty acid glyceride such as an epoxidized soybean oil, an epoxidized linseed oil, an epoxidized whale oil, or the like, a phenol novolac epoxy resin, a cresol novolac epoxy resin, or the like can be used.

The isocyanate cross-linking agent used in the present embodiment is not particularly limited so long as the isocyanate cross-linking agent includes an isocyanate group as a functional group in this compound. A known polyisocyanate cross-linking agent can be used. Specifically, a generally used water-dispersible polyisocyanate cross-linking agent can be used. The water-dispersible polyisocyanate cross-linking agent is obtained by introducing a hydrophilic group into a polyisocyanate polymer. If the water-dispersible polyisocyanate cross-linking agent is added to water and agitated, the water-dispersible polyisocyanate cross-linking agent can be dispersed as microparticles into water.

Examples of the polyisocyanate constituting the water-dispersible polyisocyanate include aliphatic isocyanates such as hexamethylene diisocyanate, trimethylhexamethylene diisocyanate, tetramethylene diisocyanate, pentamethylene diisocyanate, lysine diisocyanate, dimer acid diisocyanate, and the like; aromatic polyisocyanates such as tolylene diisocyanate, xylylene diisocyanate, diphenylmethane diisocyanate, tetramethylxylylene diisocyanate, 1,5-naphthalene diisocyanate, 1,4-naphthalene diisocyanate, 4,4′-toluidine diisocyanate, 4,4′-diphenylether isocyanate, (m- or p-)phenylene diisocyanate, 4,4′-biphenylene diisocyanate, 3,3′-biphenylene diisocyanate, bis(4-isocyanatophenyl)sulfone, isopropylidenebis(4-phenylisocyanate), and the like; and alicyclic diisocyanate compounds such as hydrogenerated xylylene diisocyanate, isophorone diisocyanate, 4,4′-methylenebis(cyclohexylisocyanate), methylcyclohexane-2,4-(or-2,6-)diisocyanate, 1,3-(or 1,4-)di(isocyanatomethyl)cyclohexane, 1,4-cyclohexane diisocyanate, 1,3-cyclopentane diisocyanate, 1,2-cyclohexane diisocyanate, and the like. As such a polyisocyanate compound, a polyisocyanate compound having an isocyanurate structure, a urethane structure, a biuret structure, an allophanate structure, a uretdione structure, a trimeric structure, or the like can also be used. A so-called blocked isocyanate obtained by an active hydrogen group blocking an isocyanate group may be used.

It is desirable that the matrix resin be formed of one of these polymers or a mixture of these polymers.

### [Elastomer Material]

It is known that the addition of an elastomer material to a resin improves the impact strength. An elastomer is a copolymer composed of the combination of a hard segment serving as a cross-link point and a soft segment exhibiting rubber elasticity, and a thermoplastic elastomer having the properties of both plastic and rubber is desirable.

Examples of the elastomer material include a urethane elastomer, an ester elastomer, an amide elastomer, an acrylic elastomer, an olefinic elastomer, a styrene elastomer, and the like. It is desirable that the elastomer be the acrylic elastomer or the ester elastomer.

Examples of the urethane elastomer include an elastomer in which the hard segment is polyurethane including a urethane group and the soft segment is polyester including an ester bond or polyether including an ether bond, and the like. The urethane group and the ester bond have polarity.

Examples of the ester elastomer include an elastomer in which the hard segment is polyester including an ester bond and the soft segment is polyester including an ester bond or polyether including an ether bond, and the like. The ester bond has polarity.

Examples of the amide elastomer include an elastomer in which the hard segment is polyamide including an amide group and the soft segment is polyester including an ester bond or polyether including an ether bond, and the like. The amide group and the ester bond have polarity.

Examples of the acrylic elastomer include an elastomer in which the hard segment is polymethylmethacrylate that is a polymer of methyl methacrylate and includes an ester bond, and the soft segment is a copolymer of butyl acrylate, 2-ethylhexyl acrylate, or the like including an ester bond, and the like. Examples of the acrylic elastomer also include an elastomer in which the hard segment is polyolefin such as polyethylene or the like and the soft segment is polymethylmethacrylate that is a polymer of methyl methacrylate and includes an ester bond, and the like. The ester bond has polarity.

Examples of the olefinic elastomer include an elastomer in which the hard segment is polyolefin such as polypropylene, polyethylene, or the like and the soft segment is ethylene propylene rubber, ethylene propylene diene rubber, or the like, and the like.

Examples of the styrene elastomer include an elastomer in which the hard segment is polystyrene and the soft segment is butadiene, isoprene, ethylene, or the like, and the like.

If the matrix resin is a polar polymer, it is desirable that the elastomer material include a polar group in terms of affinity for the matrix resin. For example, the polar group included in the elastomer material is a urethane group, an amide group, an ester bond, or the like. Particularly, it is desirable that the elastomer material include the ester bond in either one or both of the hard segment and the soft segment.

The elastomer material includes the polar group such as the ester bond or the like, whereby the elastomer material has heat resistance and can be melted and kneaded with a polar polymer, particularly a polar polymer having high heat resistance. The elastomer material including the ester bond contributes to a relatively high mechanical property, particularly an improvement in the impact strength. However, if the affinity for the matrix resin is too high depending on the number of polar groups or the type of the polar group, the elastomer material may be completely compatibilized with the matrix resin, and may not be able to form a phase separation structure. In this case, the flexural modulus is significantly decreased.

The glass-transition point (the glass-transition temperature) of the elastomer material is lower than normal temperature, whereby the elastomer material acts as an elastomer at normal temperature. It is desirable that the glass-transition point of the elastomer material be lower than 0° C. It is more desirable that the glass-transition point of the elastomer material be −20° C. or less.

The elastomer material is melted and kneaded in a melted state with the matrix resin that is a thermoplastic resin, and is finely dispersed as elastomer particles into the matrix resin, thereby improving the impact strength. Thus, it is desirable that the melting point of the elastomer material be lower than the heating temperature (the molding temperature) of the resin composition so that the elastomer material can be melted and kneaded with the matrix resin. The heating temperature of the resin composition is the temperature at which the matrix resin that is a thermoplastic polymer is melted. The heating temperature of the resin composition is higher than the glass-transition point of the matrix resin. If the matrix resin is a crystalline polymer, it is desirable that the heating temperature of the resin composition be higher than the melting point of the matrix resin. Thus, it is desirable that the melting point of the elastomer material be lower than the melting point of the matrix resin. Although the melting point of the elastomer material may be higher than the melting point of the matrix resin, this can cause thermal degradation such as a decrease in the molecular weight of the matrix resin by heating the matrix resin to melt the elastomer material, or the like. If the matrix resin is a crystalline polymer, the melting point of the elastomer material may be higher than the glass-transition point of the matrix resin. If the matrix resin is a non-crystalline polymer, the melting point of the matrix resin is not defined, and therefore, it is desirable that the melting point of the elastomer material be lower than the glass-transition point of the matrix resin.

It is desirable that the glass-transition point of the matrix resin be 50° C. or more to ensure strength when the matrix resin is used. It is also desirable that the glass-transition point of the matrix resin be 200° C. or less, taking processability into account. It is desirable that the melting point of the matrix resin be 100° C. or more, and it is desirable that the melting point of the matrix resin be 200° C. or more, taking heat resistance into account. It is desirable that the melting point of the matrix resin be 300° C. or less, taking processability into account. It is desirable that the melting point of the elastomer material be 50° C. or more to ensure strength when the elastomer material is used. It is desirable that the melting point of the elastomer material be 300° C. or less, and it is desirable that the melting point of the elastomer material be 200° C. or less, taking processability into account.

The elastomer material has rubber elasticity, i.e., flexibility, and therefore contributes to improving the impact strength of the matrix resin. When an impact is given to the molded body according to the present embodiment, the matrix resin is oriented about the elastomer particles and crazes are formed, whereby it is possible to soften the impact more efficiently. Thus, it is desirable that a large number of elastomer particles be finely dispersed. Thus, it is suitable that the particle diameter of the elastomer particles be 10 μm or less. It is more desirable that the particle diameter of the elastomer particles be 5 μm or less. It is suitable that the particle diameter of the elastomer particles be 0.1 μm or more so that the elastomer particles mechanically and efficiently function. It is more desirable that the particle diameter of the elastomer particles be 0.5 μm or more. Typically, the elastomer particles are particles formed by being dispersed and mixed by melting and kneading, and the particle diameter of such elastomer particles can be referred to as the “dispersed particle diameter” or the “dispersed particle size”.

### [Filler Particles]

It is known that the addition of filler particles to a resin improves mechanical properties such as flexural modulus. Thus, in the present embodiment, filler particles may be added to further improve the flexural modulus and the impact strength. Examples of the shape of the filler particles include many shapes such as spheres, e.g., a true sphere, an oblate sphere, and the like, a polyhedron, an amorphous shape, a plate-like shape, a scale-like shape, a needle-like shape, a fibrous shape, and the like, and any of these may be used. For example, the length of the needle-like or fibrous filler is 100 μm or less. It is desirable that the length of the needle-like or fibrous filler be 30 μm or less. It is more desirable that the length of the needle-like or fibrous filler be 10 μm or less.

Filler particles having an inorganic material as a main component are not particularly limited. Examples of the filler particles include particles of mica, glass fiber, glass sphere, zinc oxide, titanium oxide, calcium carbonate, clays, talc, silica, wollastonite, zeolite, diatomite, silica sand, fly ash, pumice powder, slate powder, alumina, white alumina, aluminum sulfate, carbon fiber, carbon nanotube, metal fiber, barium sulfate, calcium sulfate, molybdenum disulfide, shirasu balloon, fly ash balloon, and the like. Surface treatment may be performed on the filler where necessary.

The filler particles may each include a base of the inorganic material as the main component of the filler particles, and a surface layer of an organic material or an inorganic material covering the base. For example, the thickness of the surface layer is 100 nm or less. It is desirable that the thickness of the surface layer be 10 nm or less. In the filler particles having the inorganic material as the main component, the volume occupied by the inorganic material is greater than the volume occupied by the organic material. It is desirable that the volume occupied by the inorganic material be 90 volume % or more.

When an impact is given to the resin molded body, the matrix resin is oriented about the elastomer particles and crazes are formed, whereby it is possible to soften the impact more efficiently. At this time, to prevent the impact strength from decreasing due to a material defect in the filler particles, it is desirable that the filler particles have a small particle diameter. If the filler particles are coarse particles having a large particle diameter, the filler particles act as stress concentration points. Thus, the impact strength may decrease, and cracks may develop. On the other hand, to sufficiently disintegrate and disperse particles in a resin composition manufacturing process, it is desirable to avoid a dispersion failure due to particle aggregation caused by a small particle diameter. If the filler particles are fine particles having a small particle diameter, it may be difficult to disperse the filler particles due to particle aggregation in the resin composition manufacturing process. This may result in causing a material defect due to the particle aggregation and decreasing the impact strength, and cracks may develop.

Thus, for example, the particle diameter of the filler particles to be independently dispersed is 10 μm or less. It is suitable that the particle diameter of the filler particles be 5 μm or less. It is desirable that the particle diameter of the filler particles be 2 μm or less. If the particle diameter of the filler particles is 10 μm or less, it is possible to excellently prevent a decrease in the impact strength due to the addition of the filler particles. If the particle diameter is 0.2 μm or more, it is possible to excellently finely disperse the filler particles into the matrix resin, and it is possible to prevent a decrease in the impact strength. Thus, it is suitable that the particle diameter of the filler particles be 0.2 μm or more and 10 μm or less. It is more desirable that the particle diameter of the filler particles be 0.2 μm or more and 5 μm or less. It is even more desirable that the particle diameter of the filler particles be 0.2 μm or more and 2 μm or less. The resin composition may contain filler particles having a particle diameter of more than 10 μm. It is desirable that the particle diameter of the filler particles having a particle diameter of more than 10 μm be 100 μm or less. It is more desirable that the particle diameter of the filler particles having a particle diameter of more than 10 μm be 50 μm or less. It is even more desirable that the particle diameter of the filler particles having a particle diameter of more than 10 μm be 30 μm or less.

Examples of a method for measuring the particle diameter include the following method. That is, regarding a molded product obtained by molding the resin composition according to the present embodiment, a transverse direction cross-section sample of the molded product is produced by performing preprocessing such as cross-section polishing, microtomy, ion milling, or the like. The ion milling achieves high smoothness in the cross-section and can prevent particles from falling off, and therefore is suitable. If the temperature of the resin composition rises due to processing, the resin composition may be cooled by a cryogenic treatment or the like. Then, an observation is made using a scanning electron microscope (SEM) under the following conditions, thereby acquiring an SEM image of the cross-section. It is desirable to appropriately use the observation magnification according to the particle diameter of the filler particles. For example, it is desirable to make an observation at a magnification of 10,000 times if the particle diameter is 5 μm or less, and make an observation at a magnification of 1,000 times if the particle diameter is more than 5 μm. The obtained SEM image is subjected to binarization and image analysis under the following conditions, and the median diameter of the filler particles in an optional range of the cross-section of the molded body is determined as the particle diameter of the filler particles. For example, the optional range of the cross-section of the molded body can be a quadrangular region where the lengths of two adjacent sides are a length L and a length M. For example, the length L and the length M are 5 μm or more. It is desirable that the length L and the length M be 10 μm or more. For example, the length L and the length M are 500 μm or less, or for example, the length L and the length M are 100 μm or less. The length L and the length M may be the same as or different from each other. The ratio of the length L to the length M may be 0.5 to 2. The binarization and the image analysis of the SEM image are performed using image processing software ImageJ of the National Institutes of Health (available at https://imagej.nih.gov/ij/).

### CONDITIONS

### {Apparatus Name}

Schottky field emission scanning electron microscope JSM-F100 (manufactured by JEOL Ltd.)

### {Acceleration Voltage}

3 kV

### {Magnification}

10,000 times or 1,000 times

### {Measurement Range}

12.8 μm×9.6 μm (10,000 times) or 128 μm×96 μm (1,000 times)

### {Number of Evaluations}

10 areas/sample

### {Binarization and Image Analysis}

ImageJ

### {Binarization Method}

MaxEntropy (The threshold is appropriately corrected so that the filler particles can be separated by binarization. If the filler particles cannot be binarized by the image processing software, an image in which only the filler particles are visually filled by separately using painting software or the like is prepared.)

### {Method for Calculating Particle Diameter}

Median diameter (50% particle diameter)

It is desirable that in the filler particles, the base be subjected to surface treatment using a surface treatment agent such as a coupling agent, fatty acid, or the like. Regarding the filler particles subjected to the surface treatment, a commercial product subjected to surface treatment in advance may be used, or a surface treatment step may be separately provided when the resin composition is manufactured. The usage of the surface treatment agent can be calculated from the specific surface area of the filler particles as a processing target and the minimum cover area of the surface treatment agent. When filler particles having a small particle diameter are used, the specific surface area of the filler particles is large, and therefore, the usage of the surface treatment agent inevitably increases. Thus, the additive amount of the surface treatment agent to be used varies, and about 0.5 wt % to 5 wt % of the surface treatment agent is generally added to the filler particles. As the treatment method, a known method such as a dry treatment method such as an integral blend method or the like or a wet treatment method using a surface treatment agent aqueous solution or the like can be used. A surface layer formed by the surface treatment constitutes a part of the filler particles.

Examples of the surface treatment agent include silane coupling agents such as vinyltrimethoxysilane, vinyltriethoxysilane, 3-glycidoxypropyltrimethoxysilane, 3-glycidoxypropyltriethoxysilane, 3-methacryloxypropyltrimethoxysilane, 3-methacryloxypropyltriethoxysilane, 3-acryloxypropyltrimethoxysilane, 3-aminopropyltrimethoxysilane, tris-(trimethoxysilylpropyl) isocyanurate, 3-trimethoxysilylpropylsuccinic anhydride, and the like. Alternatively, a titanate or aluminate coupling agent may be used. Examples of the fatty acid include lauric acid, stearic acid, oleic acid, and the like. Among these, the silane coupling agents are desirable. One of these surface treatment agents may be used, or two or more of these surface treatment agents may be used in combination.

### [Composition Ratio of Components]

When the elastomer material is added to the matrix resin, the matrix resin forms a phase separation structure. For example, the contained amount of the matrix resin is 30 mass % or more relative to the total amount of the resin composition. It is suitable that the contained amount of the matrix resin be 40 mass % or more. It is more desirable that the contained amount of the matrix resin be 50 mass % or more. For example, the contained amount of the matrix resin is 90 mass % or less relative to the total amount of the resin composition. It is suitable that the contained amount of the matrix resin be 80 mass % or less. It is more desirable that the contained amount of the matrix resin be 70 mass % or less. The composition ratio in the resin composition can be acquired by performing thermogravimetric analysis (TGA).

The composition ratio of the elastomer material and the filler particles can be appropriately adjusted without departing from the desirable composition ratio range of the matrix resin according to the required mechanical and physical property values. If the amount of the elastomer material is large, it is possible to heighten the impact strength. If the amount of the filler particles is large, it is possible to heighten the elastic modulus. For example, the contained amount of the elastomer material is 1 mass % or more relative to the total amount of the composition. It is suitable that the contained amount of the elastomer material be 5 mass % or more. It is desirable that the contained amount of the elastomer material be 10 mass % or more. For example, the contained amount of the elastomer material is 50 mass % or less. It is suitable that the contained amount of the elastomer material be 40 mass % or less. It is desirable that the contained amount of the elastomer material be 30 mass % or less. For example, the contained amount of the filler particles is 1 mass % or more relative to the total amount of the composition. It is suitable that the contained amount of the filler particles be 5 mass % or more. It is desirable that the contained amount of the filler particles be 10 mass % or more. For example, the contained amount of the filler particles is 50 mass % or less relative to the total amount of the composition. It is suitable that the contained amount of the filler particles be 40 mass % or less. It is more desirable that the contained amount of the filler particles be 30 mass % or less.

### [Other Components]

In the present embodiment, various additives may be blended where necessary. Although the types of the additives are not particularly limited, examples of the additives include a fire retardant, a conductive material, a wax, various lubricants, a release agent, an antistatic agent, a cross-linking agent, a decomposition inhibitor, an antioxidant, a colorant, and the like. One or more of the above additives may be used in combination.

Many resins and elastomers have poor compatibility, and in many cases, a simple blend system causes interface detachment and cannot sufficiently contribute to improving the impact resistance. Thus, in many cases, a compatibilizing agent is added, and a resin and an elastomer are compatibilized with each other, thereby improving the impact strength. However, the addition of a compatibilizing agent used to compatibilize a matrix resin and a thermoplastic elastomer may result in a resin composition in a compatibilized system without a phase separation structure. Further, the flexural modulus of the resin composition obtained by adding the elastomer and the compatibilizing agent significantly decreases. The present disclosure exerts high effects because the matrix resin and the elastomer have a phase separation structure. Thus, it is desirable to use a compatibilizing agent in a range where the matrix resin and the thermoplastic elastomer can have a phase separation structure.

The resin composition according to the present embodiment may contain at least one of a metal material including a transition metal element, a compound material including a transition metal element, a metal material including a representative metal element, and a compound material including a representative metal element that are different from the inorganic material as the main component of the filler particles.

Examples of the transition metal element include titanium (Ti), chromium (Cr), manganese (Mn), iron (Fe), cobalt (Co), nickel (Ni), copper (Cu), zirconium (Zr), niobium (Nb), molybdenum (Mo), hafnium (Hf), tantalum (Ta), tungsten (W), palladium (Pd), platinum (Pt), silver (Ag), gold (Au), and the like. Examples of the representative metal element include sodium (Na), magnesium (Mg), calcium (Ca), strontium (Sr), barium (Ba), zinc (Zn), aluminum (Al), gallium (Ga), germanium (Ge), indium (In), tin (Sn), antimony (Sb), and the like. Although silicon (Si) and arsenic (As) can be classified into semimetals with germanium (Ge) and antimony (Sb), silicon (Si) and arsenic (As) are treated as non-metal elements here. Each of the metal materials is a metal simple substance or an alloy, and for example, a metal compound that is a compound including a metal element is an oxide, a nitride, a carbide, an inorganic acid salt, or an organic acid salt of the metal element. Although compounds are classified into inorganic compounds and organic compounds, an organic compound that is a metal compound, i.e., an organic metal compound, is a compound having a combination of carbon and a metal element.

The above material including the transition metal element or the representative metal element may be particles having a particle diameter of 0.1 μm or more when dispersed in the matrix resin, or may be particles having a particle diameter of less than 0.1 μm. The above material including the transition metal element or the representative metal element can be particles smaller than the elastomer particles, or can be particles dispersed in the elastomer particles. Alternatively, the above material including the transition metal element or the representative metal element may be dissolved in the matrix resin or the elastomer particles.

It is desirable that the contained amount of the above material including the transition metal element or the representative metal element be smaller than the contained amounts of the matrix resin, the inorganic material as the main component of the filler particles, and the elastomer material as the main component of the elastomer particles.

If the contained amount of a particular metal element differs between the matrix resin and the elastomer material, a distribution image (a mapping image) of the metal element is acquired, whereby it is possible to make it easy to distinguish the matrix resin and the elastomer material in an observation image. For example, aluminum (Al), germanium (Ge), antimony (Sb), or titanium (Ti) can be included in a compound as a polymerization catalyst when a polar polymer is polymerized, and can be dissolved or dispersed into the matrix resin. Alternatively, the material including the transition metal element or the representative metal element can be included in a compound as a pigment for coloring the resin composition and can be dispersed into the matrix resin. Alternatively, for example, the filler particles may include filler particles having calcium carbonate as a main component and filler particles having titanium oxide as a main component, and both filler particles may be independently dispersed.

### <Method for Manufacturing Resin Composition>

A method for manufacturing the resin composition according to the present embodiment includes the step of melting and kneading the matrix resin, the elastomer material, and other raw materials constituting the resin composition. The elastomer material is melted and kneaded in a melted state with the matrix resin, and the elastomer material is dispersed and mixed into the matrix resin, thereby improving the impact strength of the resin composition. The particle diameter of elastomer particles formed by the dispersion and mixing can be referred to as the “dispersed particle diameter” or the “dispersed particle size”. Examples of a kneading apparatus include a twin-screw extruder, a twin roll, and the like. Specifically, examples of the kneading apparatus include TEM extruder (manufactured by Shibaura Machine Co., Ltd.), TEX biaxial kneader (manufactured by The Japan Steel Works, Ltd.), PCM kneader (manufactured by Ikegai Iron Works Co., Ltd.), KNEADEX (manufactured by Nippon Coke & Engineering Co., Ltd.), and the like.

To manufacture the injection-molded body according to the present embodiment, it is desirable to use pellets of two types of resin compositions different in the average particle diameter of the elastomer particles dispersed in the matrix resin. The average particle diameter of the elastomer particles in pellets of a resin composition A can be larger than the average particle diameter of the elastomer particles in pellets of a resin composition B. For example, the difference between the average particle diameter of the elastomer particles in the pellets of the resin composition A and the average particle diameter of the elastomer particles in the pellets of the resin composition B is 0.8 μm or more. It is desirable that the difference between the average particle diameter of the elastomer particles in the pellets of the resin composition A and the average particle diameter of the elastomer particles in the pellets of the resin composition B be 1.0 μm or more. It is more desirable that the difference between the average particle diameter of the elastomer particles in the pellets of the resin composition A and the average particle diameter of the elastomer particles in the pellets of the resin composition B be 1.5 μm or more. For example, the average particle diameter of the elastomer particles in the pellets of the resin composition A is twice or more the average particle diameter of the elastomer particles in the pellets of the resin composition B. It is desirable that the average particle diameter of the elastomer particles in the pellets of the resin composition A be 3 times or more the average particle diameter of the elastomer particles in the pellets of the resin composition B. For example, the average particle diameter of the elastomer particles in the pellets of the resin composition A is 30 times or less the average particle diameter of the elastomer particles in the pellets of the resin composition B. It is desirable that the average particle diameter of the elastomer particles in the pellets of the resin composition A be 20 times or less the average particle diameter of the elastomer particles in the pellets of the resin composition B. The average particle diameter of the elastomer particles in the pellets of the resin composition A may be 10 times or less the average particle diameter of the elastomer particles in the pellets of the resin composition B. Specifically, for example, it is desirable to use the pellets of the resin composition A in which the average particle diameter of the elastomer particles is 1.5 μm or more, desirably 2.0 μm or more, and the pellets of the resin composition B in which the average particle diameter of the elastomer particles is less than 1.5 μm, desirably 1.0 μm or less.

In the melting kneading step, generally, a shearing force applied to a melted and kneaded product becomes small by making the discharge amounts constant and decreasing the screw rotation speed. Normally, the elastomer material is present as an aggregate. Thus, the shearing force applied to the melted and kneaded product becomes small, whereby it is possible to disperse the elastomer particles in the matrix resin in a larger particle size. Besides, it is possible to change the dispersed particle size also by adding a thickener to the elastomer material, adding a dispersant to the elastomer material, or controlling the concentration or the surface tension of the elastomer material.

The resin composition A is a resin composition kneaded under a melting kneading condition α. As the melting kneading condition α, a kneading condition can be adjusted by, for example, decreasing the screw rotation speed so that the average particle diameter of the elastomer particles is 1.5 μm or more, desirably 2.0 μm or more. Similarly, the resin composition B is a resin composition kneaded under a melting kneading condition β. As the melting kneading condition β, a kneading condition can be adjusted by, for example, increasing the screw rotation speed so that the average particle diameter of the elastomer particles is less than 1.5 μm, desirably 1.0 μm or less.

### <Method for Molding Injection-Molded Body>

The molded body according to the present embodiment is formed by molding the resin composition according to the present embodiment. As a molding method, injection molding in a metal mold is used. The resin composition molded by the injection molding can be referred to as an “injection-molded body”. Generally, an injection molding apparatus is a screw-type injection molding apparatus. Also in the present embodiment, a screw-type injection molding apparatus is desirable.

To mold the injection-molded body according to the present embodiment, it is desirable to use the pellets of the resin composition A and the pellets of the resin composition B by blending the pellets. It is desirable that the resin composition A be 50 parts by mass or more and 200 parts by mass or less relative to 100 parts by mass of the resin composition B. It is more desirable that the resin composition A be 50 parts by mass or more and 100 parts by mass or less.

If the blended resin composition is input to an injection molding machine and molded, and when a melted and kneaded product is extruded in the injection molding machine, elastomer particles having high fluidity and a large particle diameter flow first and constitute a portion close to the metal mold. Generally, on the outermost surface of the blended resin composition in contact with the metal mold, the matrix resin having a high melting point or glass-transition point compared to that of the elastomer material is solidified first, thereby forming the third portion 3 where the ratio of the elastomer to the matrix resin is low. This third portion 3 is referred to as a “skin layer”. A core layer is formed inside the skin layer (on the side away from the metal mold). In the present embodiment, the core layer can include the first portion 1 and the second portion 2. It is considered that elastomer particles having a large particle diameter remain near the metal mold and form the second portion 2. Further, elastomer particles having a small particle diameter and flowing next form the first portion 1. By melting and kneading in the injection molding machine, the elastomer particles in the pellets of the resin composition A are divided and/or combined, or the elastomer particles in the pellets of the resin composition B are divided and/or be combined. The elastomer particles in the pellets of the resin composition A and the elastomer particles in the pellets of the resin composition B are also combined. Thus, the particle diameter of the elastomer particles in the injection-molded body is correlated to the particle diameters of the elastomer particles in the pellets, but does not necessarily coincide with the particle diameters of the elastomer particles in the pellets.

### <Evaluations>

A method for measuring the particle diameter of the elastomer particles is illustrated. A target of the measurement of the particle diameter of the elastomer may be the molded molded body, or may be strands or pellets after melting and kneading. Moreover, processing such as resin embedding or the like may be performed on the molded molded body, the strands, or the pellets. A transverse direction cross-section sample is produced by performing preprocessing such as cross-section polishing, microtomy, ion milling, or the like. Then, an observation is made using a scanning electron microscope (SEM) at an acceleration voltage of 3 kV, thereby acquiring an SEM image of the cross-section. It is desirable to appropriately use the observation magnification according to the particle diameter of the elastomer. For example, it is desirable to make an observation at a magnification of 10,000 times if the particle diameter is 5 μm or less, and make an observation at a magnification of 1,000 times if the particle diameter is more than 5 μm. For example, the obtained SEM image is subjected to binarization and image analysis using ImageJ or the like, and the particle diameter is calculated using a particle calculation method based on the median diameter. Similarly, the particle diameters in 10 SEM images are calculated, and the average value of the particle diameters is determined as the average particle diameter of the elastomer particles. The binarization and the image analysis of the SEM image are performed using image processing software ImageJ of the National Institutes of Health (available at https://imagej.nih.gov/ij/).

A method for observing the molded body is illustrated. Examples of a method for creating a cross-section of the molded body to be observed include the following method. A transverse direction cross-section sample of the molded body is produced by using a cross-section fractured by a Charpy impact test and also performing processing such as cross-section polishing, microtomy, ion milling, or the like. Then, an observation is made using a scanning electron microscope (SEM) at an acceleration voltage of 3 kV, thereby acquiring an SEM image of the cross-section. It is desirable to make an observation at a magnification of about 5,000 times as the observation magnification.

Examples of a method for measuring the ratio of the elastomer to the matrix resin of the molded body include the following method. Regarding the molded body according to the present embodiment, a transverse direction cross-section sample of the molded body is produced by performing preprocessing such as cross-section polishing, microtomy, ion milling, or the like. Then, analysis is performed in an area range of 10² μm² or more and 130² μm² or less, for example, a range of a 25 μm square (252 μm²), in the cross-section using Fourier transform infrared spectroscopic analysis apparatus Spotlight400 (manufactured by PerkinElmer, Inc.). It is desirable that an analysis target be a plurality of area ranges linearly arranged in a direction perpendicular to the surface 4 (the depth direction of the molded body) along the cross-section. For example, in FIG. 1, the area ranges 21, 22, 11, and 12 are linearly arranged. It is desirable to acquire statistical values such as the average value, the maximum value, and the like using the analysis results of the plurality of area ranges. The matrix resin alone and the elastomer material alone are also measured. All the data is normalized by the peak values of the measurements. The ratio of the elastomer to the matrix resin is calculated on the premise that the measurement result of the matrix resin is an elastomer ratio of 0%, and the measurement result of the elastomer material is an elastomer ratio of 100%, using the value of 1160 cm⁻¹ after the normalization.

Examples of a method for measuring the impact strength of the molded body include the following method. A strip test piece is molded in compliance with JIS K7111. The test piece notched by a notch processing machine is destroyed with an energy of 1 J from the back surface of the notched test piece in compliance with JIS K7111-1 using a Charpy impact testing machine. The energy required for the destruction is calculated from the angle at which a hammer raised to 150° is raised after the destruction of the test piece, and is determined as the Charpy impact value.

It is desirable that the Charpy impact value of the molded body be 3 kJ/m² or more. It is more desirable that the Charpy impact value of the molded body be 6 kJ/m² or more. If the Charpy impact value of the molded body is less than 3 kJ/m², cracks may be generated in a drop test or the like.

Examples of a method for measuring the flexural modulus of the molded body include the following method. A three-point bending jig is installed in a universal material testing machine in compliance with JIS K7171, the molded strip test piece is measured under the conditions that the distance between fulcrums is 64 mm and the descending speed of an indenter is 2 mm/minute. Then, the flexural modulus is calculated from the stress gradient of a prescribed strain section (0.05% to 0.25%).

It is desirable that the flexural modulus of the molded body be 1,500 MPa or more. It is more desirable that the flexural modulus of the molded body be 1,700 MPa or more. This is because if the flexural modulus is in this range, deformation caused by an assumed external force is in an elastic deformation region, and the shape is not deformed. If, on the other hand, the flexural modulus is less than 1,200 MPa, plastic deformation may be caused by the assumed external force.

### <<Device>>

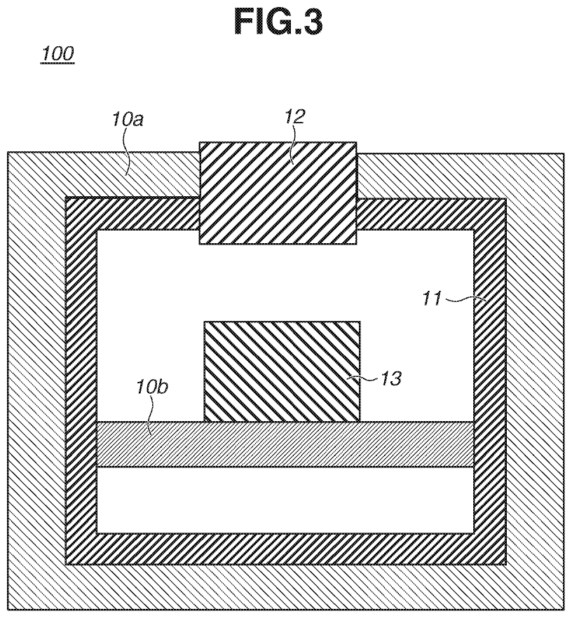

A device 100 illustrated in FIG. 3 includes the injection-molded body 10 according to the present embodiment as members 10a and 10b. Examples of the device 100 include office devices such as a printer, a copying machine, and the like, medical devices such as a computed tomography (CT) apparatus and the like, video devices such as a projector, a display, and the like, and the like. These various devices each include at least any of an electric component 13, an optical component 12, and a metal component 11 in addition to the members 10a and 10b composed of the injection-molded body according to the present embodiment. The electric component 13, the optical component 12, or the metal component 11 achieves the function of the device 100. The metal component 11 can also be used for a housing for ensuring the mechanical strength of the device 100.

The members 10a and 10b composed of the injection-molded body 10 according to the present embodiment can be used as members for ensuring the mechanical strength of the device 100 or mechanically protecting the device 100. The member 10a composed of the injection-molded body according to the present embodiment may be an exterior body, such as an exterior cover, of the device 100. The exterior body may be fixed to the metal housing (the metal component 11). The member 10b composed of the injection-molded body 10 according to the present embodiment may be an interior body, such as a mechanism component, of the device 100. The interior body may be fixed to the metal housing (the metal component 11).

### EXAMPLES

Materials used in the present embodiment are as illustrated below.

### (A) Matrix Resin

TABLE 1

| | | | Glass- | |
|---|---|---|---|---|
| | | | Transition | Melting |
| | | | Point | Point |
| | Compound | Product Name | [° C.] | [° C.] |
| A-1 | Polyethylene | “TRN-8550FF” | 71 | 252 |
| | terephthalate | by Teijin Limited | | |

### (B) Elastomer Material

TABLE 2

| | | | Glass- | |
|---|---|---|---|---|
| | | | Transition | Melting |
| | | | Point | Point |
| | Compound | Product Name | [° C.] | [° C.] |
| B-1 | Acrylic elastomer | “KURARITY LA4285” | −52 | 75 |
| | (including ester | by Kuraray Co., Ltd. | | |
| | bond) | | | |
| B-2 | Acrylic elastomer | “KURARITY LA2330” | −55 | 68 |
| | (including ester | by Kuraray Co., Ltd. | | |
| | bond) | | | |
| B-3 | Ester elastomer | “ESTERAR EA-A80CR” | −56 | 222 |
| | (including ester | by Aronkasei Co., Ltd. | | |
| | bond) | | | |
| B-4 | Acrylic elastomer | “Acryft WD106” | −39 | 107 |
| | (including ester | by Sumitomo Chemical | | |
| | bond) | Company, Limited | | |
| B-5 | Acrylic elastomer | “BONDFAST BF-30C” | −29 | 96 |
| | (including ester | by Sumitomo Chemical | | |
| | bond) | Company, Limited | | |

### (C) Filler Particles

The average particle diameter [μm] of a filler illustrated in table 3 is the catalog value of a product.

TABLE 3

| | | | Average Particle |
|---|---|---|---|
| | | | Diameter |
| | Compound | Product Name | [μm] |
| C-1 | Calcium | “NITOREX#23P” | 1.0 |
| | carbonate | by Nitto Funka Kogyo K.K. | |
| | particles | | |
| C-2 | Silica | “Fused silica SFP-20M” | 0.4 |
| | particles | by Denka Company Limited | |

### (D) Additives

### (D-1) Compatibilizing Agent: “AX8700” Manufactured by Tokyo Zairyo Co., Ltd.

### <<Manufacturing of Pellets of Resin Compositions 1A to 8A and 1B to 8B>>

### <Manufacturing of Pellets of Resin Compositions 1A and 1B>

A matrix resin illustrated in table 4 was dried in advance so that the moisture content was 100 ppm. This was to prevent hydrolysis in kneading, and conditions such as temperature and time differed depending on the resin type. The moisture content was measured using polymer moisture meter “AQUATRAC-V (product name) manufactured by ITS Japan Inc.”.

Then, components were added so that the mass % of each component in a resin composition to be ultimately obtained was the blended amount illustrated in table 4, and a blended product of raw materials was prepared. Strands were prepared by melting and kneading the blended product under the conditions of a cylinder temperature of 260° C. and a screw rotation speed of 50 rpm using twin-screw extruder “PCM30 (product name) manufactured by Ikegai Corp.” and were cut by a pelletizer, thereby obtaining pellets of a resin composition 1A.

Pellets of a resin composition 1B were also obtained similarly except that the screw rotation speed was changed to 250 rpm.

### <Manufacturing of Pellets of Resin Compositions 2A to 8A and 2B to 8B>

Pellets of resin compositions 2A to 8A and 2B to 8B were manufactured similarly to the manufacturing of the pellets of the resin composition 1A and the pellets of the resin composition 1B except that the mass % of each component was changed to achieve the blended amount illustrated in table 4.

### <Measurement of Particle Diameter of Elastomer>

A resin embedding process was performed on the obtained pellets, and the particle diameter of the elastomer in the matrix resin was confirmed. An observation cross-section was polished using polishing paper of grain sizes #400 to #2500 in order and then buffed using a diamond slurry having a particle diameter of 0.5 μm, thereby preparing a cross-section to be observed. An observation was made at a magnification of 10,000 times under the condition of an acceleration voltage of 3 kV using a scanning electron microscope “JSM-F100 (product name) manufactured by JEOL Ltd.”. An obtained SEM image was subjected to binarization and image analysis using ImageJ, and the particle diameter was calculated using a particle calculation method based on the median diameter. Similarly, the particle diameters in 10 SEM images were calculated, and the average value of the particle diameters was determined as the particle diameter of the elastomer in the resin composition and illustrated in Table 4. Table 4 also describes the differences between the average particle diameters of the elastomer particles in the resin compositions 1A to 6A and the average particle diameters of the elastomer particles in the resin compositions 1B to 6B, respectively. These differences are calculated from the average particle diameters of the elastomer particles in the resin compositions 1A to 6A and the average particle diameters of the elastomer particles in the resin compositions 1B to 6B. The ratios of the average particle diameters of the elastomer particles in the resin compositions 1A to 6A to the average particle diameter of the elastomer particles in the resin compositions 1B to 6B, respectively, can also be calculated from the average particle diameters of the elastomer particles, and therefore are not described.

To the resin compositions 7A and 7B, a compatibilizing agent D-1 that was compatibilized with each of the matrix resin and the elastomer and included a plurality of chemical structures was added. The compatibility of the elastomer in the matrix resin was improved by adding the compatibilizing agent, whereby elastomer particles were not observed. To the resin compositions 8A and 8B, an elastomer B-5 including a functional group highly compatible with the matrix resin was added. The elastomer was sufficiently compatibilized with the matrix resin, whereby elastomer particles were not observed.

TABLE 4

| | | | | | | | | | | | | | | | |
|---|---|---|---|---|---|---|---|---|---|---|---|---|---|---|---|
| 1A | 1B | 2A | 2B | 3A | 3B | 4A | 4B | 5A | 5B | 6A | 6B | 7A | 7B | 8A | 8B |

| | | | | | | | | | | |
|---|---|---|---|---|---|---|---|---|---|---|
| Composition | Matrix | Type | A-1 | A-1 | A-1 | A-1 | A-1 | A-1 | A-1 | A-1 |
| | Resin | Contained | 80 | 80 | 80 | 85 | 65 | 65 | 75 | 80 |
| | | Amount | | | | | | | | |
| | | [wt %] | | | | | | | | |
| | Elastomer | Type | B-1 | B-2 | B-3 | B-4 | B-1 | B-1 | B-1 | B-5 |
| | | Contained | 20 | 20 | 20 | 15 | 15 | 20 | 20 | 20 |
| | | Amount | | | | | | | | |
| | | [wt %] | | | | | | | | |
| | Filler | Type | — | — | — | — | C-1 | C-2 | — | — |
| | | Contained | 0 | 0 | 0 | 0 | 20 | 15 | 0 | 0 |
| | | Amount | | | | | | | | |
| | | [wt %] | | | | | | | | |
| | Compati- | Type | — | — | — | — | — | — | D-1 | — |
| | bilizing | Contained | 0 | 0 | 0 | 0 | 0 | 0 | 5 | 0 |
| | Agent | Amount | | | | | | | | |

[wt %]

| | | | | | | | | | | | | | | | | |
|---|---|---|---|---|---|---|---|---|---|---|---|---|---|---|---|---|
| Screw Rotation Speed [rpm] | 50 | 250 | 50 | 250 | 50 | 250 | 50 | 250 | 50 | 250 | 50 | 250 | 50 | 250 | 50 | 250 |
| Particle Diameter of | 2.1 | 0.3 | 2.0 | 0.1 | 3.1 | 0.9 | 2.6 | 0.6 | 2.3 | 0.2 | 2.0 | 0.4 | — | — | — | — |
| Elastomer [μm] | | | | | | | | | | | | | | | | |

| | | | | | | | | |
|---|---|---|---|---|---|---|---|---|
| Difference between Particle | 1.8 | 1.9 | 2.2 | 2.0 | 2.1 | 1.6 | — | — |
| Diameters of Elastomer [μm] | | | | | | | | |

### Examples 1 to 8 and Comparative Examples 1 to 4

The pellets of the resin compositions A and B illustrated in table 5 were blended at the ratio in table 5 and dried in advance so that the moisture content was 100 ppm. The moisture content was measured by a method similar to that for the moisture content of the matrix resin. Then, the pellets of the resin compositions A and B were injection-molded at a cylinder temperature of 280° C. and a metal mold temperature of 30° C. using injection molding machine “SE-180D (product name) manufactured by Sumitomo Heavy Industries, Ltd.”, thereby molding a strip test piece type B1 defined by JIS K7152-1 (a length of 80 mm×a width of 10 mm×a thickness of 4 mm).

### <Charpy Impact Value>

The molded strip test piece was subjected to notch (shape A) processing using notch processing machine “No. 189-PN (product name) manufactured by Yasuda Seiki Seisakusho, Ltd.” in compliance with JIS K7111, and a central portion of the test piece was cut out (notched) at a depth of 2 mm, a notch tip radius of 0.25 mm, and 45°. The test piece was destroyed with an energy of 1 J from the back surface of the cutout of the test piece in compliance with JIS K7111-1 using Charpy impact testing machine “No. 258 (product name) manufactured by Yasuda Seiki Seisakusho, Ltd.”. The energy required for the destruction was calculated from the angle at which a hammer raised to 150° was raised after the destruction of the test piece. Then, the average value of the measured values of five test pieces was determined as the Charpy impact value.

The result of the Charpy impact test of each of the measurements was evaluated by the following indices. Table 5 illustrates the results of the evaluations. The greater the Charpy impact strength is, the higher the evaluation is.
A: The Charpy impact strength is 6 kJ/m² or more.
B: The Charpy impact strength is 3 kJ/m² or more and less than 6 kJ/m².
C: The Charpy impact strength is 1.53 kJ/m² or more and less than 3 kJ/m².
D: The Charpy impact strength is less than 1.5 kJ/m².

### <Flexural Modulus>

A three-point bending jig was installed in universal material testing machine “5581 (product name) manufactured by Instron” in compliance with JIS K7171, the molded strip test piece was measured under the conditions that the distance between fulcrums was 64 mm and the descending speed of an indenter was 2 mm/minute. Then, the flexural modulus was calculated from the stress gradient of a prescribed strain section (0.05% to 0.25%). The average value of the measured values of five test pieces was determined as the flexural modulus.

The flexural modulus was evaluated by the following criteria. Table 5 illustrates the results. The greater the flexural modulus is, the higher the evaluation is.
A: The flexural modulus is 1,700 MPa or more.
B: The flexural modulus is 1,500 MPa or more and less than 1,700 MPa.
C: The flexural modulus is 1,200 MPa or more and less than 1,500 MPa.
D: The flexural modulus is less than 1,200 MPa.

### <Ratio of Elastomer to Matrix Resin>

A cross-section of a central portion of the molded strip test piece was obtained, and the ratio of the elastomer in the matrix was calculated. A measurement cross-section was polished using polishing paper of grain sizes #400 to #2500 in order and then buffed using a diamond slurry having a particle diameter of 0.5 μm, thereby preparing a cross-section to be measured. Analysis was continuously performed in a perpendicular direction from the outermost surface side in a range of a 25 μm square using Fourier transform infrared spectroscopic analysis apparatus Spotlight400 (manufactured by PerkinElmer, Inc.). The matrix resin alone and the elastomer alone were also measured. All the data was normalized by the peak values of the measurements. The ratio of the elastomer to the matrix resin was calculated on the premise that the measurement result of the matrix resin alone was an elastomer ratio of 0%, and the measurement result of the elastomer alone was an elastomer ratio of 100%, using the value of 1160 cm⁻¹ after the normalization. The maximum value of the ratio of the elastomer to the matrix resin in a region 50 μm or more and less than 500 μm inside from the surface of the molded body was determined as the elastomer ratio in the second portion. A region 500 μm or more inside from two surfaces opposed to each other was similarly measured, and the average value of the ratio of the elastomer to the matrix resin in this region was determined as the elastomer ratio in the first portion. Table 5 illustrates the elastomer ratio in the second portion/the elastomer ratio in the first portion. In example 1, the elastomer ratio in the second portion is 33.5%, and the elastomer ratio in the first portion is 14.0%. In example 4, the elastomer ratio in the second portion is 29%, and the elastomer ratio in the first portion is 12.5%. In comparative example 1, the elastomer ratio in the second portion is 21.0%, and the elastomer ratio in the first portion is 19.0%.

### <Average Particle Sizes of Elastomer Particles in First Portion and Second Portion>

A central portion of the molded strip test piece was observed in the cross-sectional direction, and the average particle sizes of the elastomer particles in the first portion and the second portion were measured. As an observation cross-section, a fractured cross-section of the test piece subjected to the Charpy impact test was used. The structure was observed at a magnification of 5,000 times under the condition of an acceleration voltage of 3 kV using scanning electron microscope “JSM-F100 (product name) manufactured by JEOL Ltd.”. An SEM image obtained by capturing the second portion was subjected to binarization and image analysis using ImageJ, and the average particle diameter of the elastomer was calculated. The thresholds were appropriately corrected according to the shape of the elastomer and the contrast. If the shape of the elastomer particles was not a circle, the number of the elastomer particles and the area of the elastomer were counted and converted, thereby calculating the average particle diameter of the elastomer.

Similarly, 10 SEM images were processed, and the largest value of the average particle diameter of the elastomer was determined as the average particle diameter of the elastomer in the second portion. Similarly, the first portion was captured, and the average particle diameter of the elastomer was calculated. Table 5 illustrates the average particle diameters in the second portion and the first portion. Table 5 also describes the difference between the average particle diameter of the elastomer particles in the first portion and the average particle diameter of the elastomer particles in the second portion. This difference was calculated from the average particle diameter of the elastomer particles in the first portion and the average particle diameter of the elastomer particles in the second portion. The ratio of the average particle diameter of the elastomer particles in the second portion to the average particle diameter of the elastomer particles in the first portion can also be calculated from the average particle diameters of the elastomer particles, and therefore is not described.

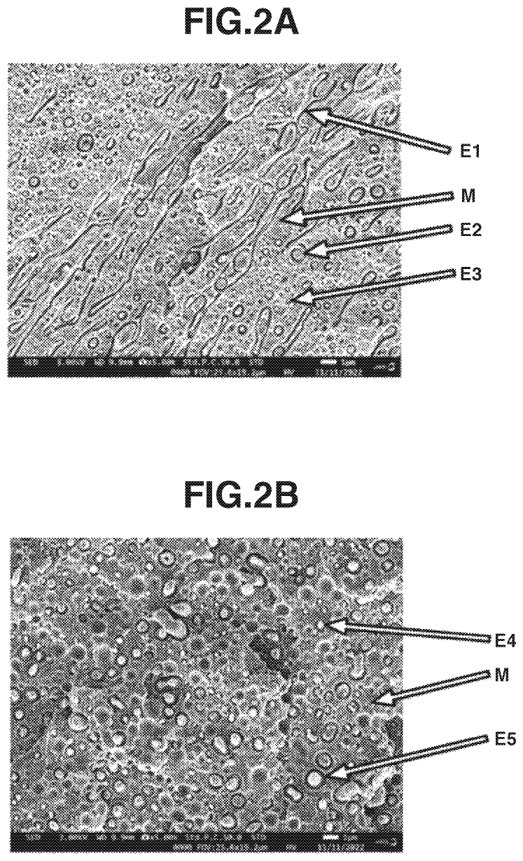

FIG. 2A illustrates a cross-sectional SEM image obtained by capturing the second portion 2 of the injection-molded body according to example 1. FIG. 2B illustrates a cross-sectional SEM image obtained by capturing the first portion 1 of the injection-molded body according to example 1. In each of FIGS. 2A and 2B, the field of view of the SEM image is 25.6 μm×19.2 μm, and the scale width written at the lower right of the SEM image is 1 μm. FIG. 2A illustrates the state where a region 100 μm to 200 μm away inside from the surface in the thickness direction of the injection-molded body is observed. FIG. 2B illustrates the state where a region about 1 mm away inside from the surface in the thickness direction of the injection-molded body is observed. In each of FIGS. 2A and 2B, an arrow M indicates the matrix resin. In FIG. 2B, an arrow E1 indicates elastomer dispersed by spreading in the form of an amoeba having a length of about 5 μm in an oblique direction. In FIG. 2A, an arrow E2 indicates elastomer dispersed in the form of a sphere having a diameter of about 1 μm, and an arrow E3 indicates elastomer dispersed in the form of a sphere having a diameter of less than 0.5 μm. In FIG. 2B, an arrow E4 indicates elastomer dispersed in the form of a sphere having a diameter of about 0.5 μm, and an arrow E5 indicates elastomer dispersed in the form of a sphere having a diameter of about 1 μm.

It is guessed that the elastomer dispersed by spreading in the form of an amoeba having a length of 5 μm or more as illustrated in the second portion 2 was obtained by, when the melted resin flowed in the metal mold, elastomer particles extending in the flow direction. In the first portion 1, elastomer dispersed by spreading in the form of an amoeba having a length of 5 μm or more as illustrated in the second portion 2 was not confirmed.

TABLE 5

| | | Example | | | | | | | | Comparative Example | | | |
|---|---|---|---|---|---|---|---|---|---|---|---|---|---|
| | | 1 | 2 | 3 | 4 | 5 | 6 | 7 | 8 | 1 | 2 | 3 | 4 |
| Resin Composition | A | 1A | 1A | 1A | 2A | 3A | 4A | 5A | 6A | 1A | — | 7A | 8A |
| | B | 1B | 1B | 1B | 2B | 3B | 4B | 5B | 6B | — | 1B | 7B | 8B |
| | Mass Ratio | 1:1 | 1:2 | 2:1 | 1:1 | 1:1 | 1:1 | 1:1 | 1:1 | 1:0 | 0:1 | 1:1 | 1:1 |
| | (A:B) | | | | | | | | | | | | |
| Elastomer Ratio in Second Portion/ | | 2.4 | 1.8 | 3.0 | 2.3 | 2.5 | 1.5 | 1.9 | 2.1 | 1.1 | 1.2 | 1.0 | 1.1 |
| Elastomer Ratio in First Portion | | | | | | | | | | | | | |
| Particle Size of | First Portion | 0.4 | 0.8 | 0.3 | 0.1 | 0.9 | 0.6 | 0.2 | 0.5 | 1.6 | 0.3 | — | — |
| Elastomer [μm] | Second Portion | 1.8 | 2.5 | 1.5 | 1.7 | 3.3 | 2.1 | 1.2 | 1.7 | 2.2 | 0.9 | — | — |

| | | | | | | | | | | | | |
|---|---|---|---|---|---|---|---|---|---|---|---|---|
| Difference between Particle Sizes | 1.4 | 1.7 | 1.2 | 1.6 | 2.4 | 1.5 | 1.0 | 1.2 | 0.6 | 0.6 | — | — |
| of Elastomer [μm] | | | | | | | | | | | | |
| Impact Strength | A | A | B | A | A | B | B | B | D | C | C | A |
| Flexural Modulus | A | A | A | B | B | A | A | A | B | B | C | D |

In examples 1 to 7, the elastomer ratio in the second portion/the elastomer ratio in the first portion was 1.3 or more, and the elastomer ratio in the second portion was sufficiently high. Thus, the flexural modulus and the impact strength of each of these molded bodies were both excellent.

In comparative examples 1 to 4, the elastomer ratio in the second portion/the elastomer ratio in the first portion was less than 1.3, and the elastomer ratio in the second portion was low. In comparative example 1, it is guessed that since only the resin composition A was used, the particle diameters of all the elastomer particles were large, whereby sufficient impact strength was not able to be exhibited. In comparative example 2, it is guessed that since only the resin composition B was used, the particle diameters of all the elastomer particles were small, whereby sufficient impact strength was not able to exhibited. In comparative examples 3 and 4, it is guessed that since the compatibility between the matrix resin and the elastomer material was high, elastomer particles were not confirmed in both the first portion and the second portion by observing the SEM image. Thus, the molded body according to comparative example 3 was not able to exhibit sufficient flexural modulus and sufficient impact strength, and the molded body according to comparative example 4 was not able to exhibit sufficient flexural modulus.

The present disclosure is not limited to the above embodiments and examples, and can be modified in many ways in the technical idea of the present disclosure. The effects described in the embodiments and examples are merely a list of the most suitable effects provided by the present disclosure, and the effects of the present disclosure are not limited to those described in the embodiments and examples.

A new item can be added to at least one embodiment. The disclosed content of the specification includes not only items explicitly described in the specification but also all items that can be understood from the specification and the drawings attached to the specification.

Regarding the specific numerical ranges illustrated in the specification, the description “e to f” (e and f are numbers) means e or more and/or f or less. Regarding the illustrated specific numerical ranges, if the range “i to j” and the range “m to n” (i, j, m, and n are numbers) are both described, a set of the lower limit and the upper limit is not limited to a set of i and j or a set of m and n. For example, consideration may be given by combining the lower limits and the upper limits of a plurality of sets. That is, if the range “i to j” and the range “m to n” are both described, consideration may be given in the range “i to n” or consideration may be given in the range “m to j” without causing a contradiction. Being e or more means being e or greater than e (more than e), and a value greater than e may be adopted without adopting e. Being f or less means being f or smaller than f (less than f), and a value smaller than f may be adopted without adopting f.

The disclosed content of the specification includes a complement of individual concepts described in the specification. That is, for example, if the specification states that “A is B”, and even if the specification omits the statement that “A is not B”, the specification can be said to state that “A is not B”. This is because the statement that “A is B” is based on the premise of the consideration that “A is not B”.

### INCLUDED CONFIGURATIONS

The disclosure of the present embodiment includes the following configurations.

### (Configuration 1)

An injection-molded body including a matrix resin and a thermoplastic elastomer dispersed in the matrix resin, the injection-molded body comprising:
a first portion away from a surface of the injection-molded body; and
a second portion between the first portion and the surface,
wherein a ratio of the elastomer to the matrix resin in an area range of 10² μm² or more and 130² μm² or less in the second portion is 1.3 times or more a ratio of the elastomer to the matrix resin in an area range of 10² μm² or more and 130² μm² or less in the first portion.

### (Configuration 2)

The injection-molded body according to configuration 1,
wherein in the first portion, the elastomer is elastomer particles dispersed in the matrix resin, and
wherein in the second portion, the elastomer is elastomer particles dispersed in the matrix resin.

### (Configuration 3)

The injection-molded body according to configuration 2, wherein an average particle diameter of the elastomer particles in the second portion is larger than an average particle diameter of the elastomer particles in the first portion.

### (Configuration 4)

The injection-molded body according to configuration 2 or 3, wherein a difference between the average particle diameter of the elastomer particles in the second portion and the average particle diameter of the elastomer particles in the first portion is 0.8 μm or more.

### (Configuration 5)

The injection-molded body according to configuration 2 or 3, wherein the average particle diameter of the elastomer particles in the first portion is 1.0 μm or less.

### (Configuration 6)

The injection-molded body according to configuration 2 or 3, wherein the average particle diameter of the elastomer particles in the second portion is greater than 1.0 μm.

### (Configuration 7)

The injection-molded body according to configuration 2 or 3, wherein the average particle diameter of the elastomer particles in the second portion is twice or more the average particle diameter of the elastomer particles in the first portion.

### (Configuration 8)

The injection-molded body according to any one of configurations 1 to 7,
wherein the ratio of the elastomer to the matrix resin in the area range of 10² μm² or more and 130² μm² or less in the second portion is 10% or more, and
wherein the ratio of the elastomer to the matrix resin in the area range of 10² μm² or more and 130² μm² or less in the first portion is less than 50%.

### (Configuration 9)

The injection-molded body according to any one of configurations 1 to 8,
wherein the ratio of the elastomer to the matrix resin in the area range of 10² μm² or more and 130² μm² or less in the second portion is 1.5 times or more the ratio of the elastomer to the matrix resin in the area range of 10² μm² or more and 130² μm² or less in the first portion.

### (Configuration 10)

The injection-molded body according to any one of configurations 1 to 9, wherein the ratio of the elastomer to the matrix resin in the area range of 10² μm² or more and 130² μm² or less in the first portion is an average value in the first portion.

### (Configuration 11)

The injection-molded body according to any one of configurations 1 to 10, wherein the ratio of the elastomer to the matrix resin in the area range of 10² μm² or more and 130² μm² or less in the second portion is a maximum value in the second portion.

### (Configuration 12)

The injection-molded body according to any one of configurations 1 to 11, wherein the first portion is in a region 250 μm or more away inside from the surface, and the second portion is in a region 50 μm or more and less than 500 μm away inside from the surface.

### (Configuration 13)

The injection-molded body according to any one of configurations 1 to 12, further comprising a third portion between the second portion and the surface,
wherein a ratio of the elastomer to the matrix resin in an area range of 10² μm² or more and 130² μm² or less in the third portion is lower than the ratio of the elastomer to the matrix resin in the area range of 10² μm² or more and 130² μm² or less in the first portion.

### (Configuration 14)

The injection-molded body according to configuration 13, wherein the third portion is in a region less than 50 μm away inside from the surface.

### (Configuration 15)

The injection-molded body according to any one of configurations 1 to 14, wherein the matrix resin is polyester.

### (Configuration 16)

The injection-molded body according to any one of configurations 1 to 15, wherein the elastomer is an acrylic elastomer.

### (Configuration 17)

The injection-molded body according to any one of configurations 1 to 16, wherein a melting point of the elastomer is lower than a glass-transition point or a melting point of the matrix resin.

### (Configuration 18)

The injection-molded body according to any one of configurations 1 to 17, further comprising filler particles having an inorganic material dispersed in the matrix resin as a main component.

### (Configuration 19)

A device comprising:
a member composed of the injection-molded body according to any one of configurations 1 to 18; and
at least any of an electric component, a metal component, and an optical component.

### (Configuration 20)

The device according to configuration 19, wherein the member is an exterior body.

### (Configuration 21)

A method for manufacturing an injection-molded body, comprising:
injection-molding a mixture of pellets of a first resin composition obtained by dispersing first elastomer particles in a matrix resin and pellets of a second resin composition obtained by dispersing second elastomer particles in the matrix resin,
wherein a difference between an average particle diameter of the first elastomer particles and an average particle diameter of the second elastomer particles is 0.8 μm or more.

### (Configuration 22)

The method for manufacturing an injection-molded body according to configuration 21, wherein the average particle diameter of the first elastomer particles is twice or more the average particle diameter of the second elastomer particles.

### (Configuration 23)

The method for manufacturing an injection-molded body according to configuration 21 or 22, wherein the average particle diameter of the first elastomer particles is 1.5 μm or more, and the average particle diameter of the second elastomer particles is less than 1.5 μm.

### (Configuration 24)

The method for manufacturing an injection-molded body according to any one of configurations 21 to 23, further comprising manufacturing the first resin composition,
wherein the manufacturing of the first resin composition is melting and kneading a matrix resin and an elastomer material and dispersing the first elastomer particles in the matrix resin.

The present disclosure is not limited to the above embodiments and various changes and modifications can be made within the spirit and scope of the present disclosure. Therefore, to apprise the public of the scope of the present disclosure, the following claims are made.

According to the present embodiment, it is possible to provide an injection-molded body having excellent mechanical properties.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

1. An injection-molded body including a matrix resin and a thermoplastic elastomer dispersed in the matrix resin, the injection-molded body comprising:
a first portion away from a surface of the injection-molded body; and
a second portion between the first portion and the surface,
wherein a ratio of the elastomer to the matrix resin in an area range of 10² μm² or more and 130² μm² or less in the second portion is 1.3 times or more a ratio of the elastomer to the matrix resin in an area range of 10² μm² or more and 130² μm² or less in the first portion.

2. The injection-molded body according to claim 1,
wherein in the first portion, the elastomer is elastomer particles dispersed in the matrix resin, and
wherein in the second portion, the elastomer is elastomer particles dispersed in the matrix resin.

3. The injection-molded body according to claim 2, wherein an average particle diameter of the elastomer particles in the second portion is larger than an average particle diameter of the elastomer particles in the first portion.

4. The injection-molded body according to claim 2, wherein a difference between the average particle diameter of the elastomer particles in the second portion and the average particle diameter of the elastomer particles in the first portion is 0.8 μm or more.

5. The injection-molded body according to claim 2, wherein the average particle diameter of the elastomer particles in the first portion is 1.0 μm or less.

6. The injection-molded body according to claim 2, wherein the average particle diameter of the elastomer particles in the second portion is greater than 1.0 μm.

7. The injection-molded body according to claim 2, wherein the average particle diameter of the elastomer particles in the second portion is twice or more the average particle diameter of the elastomer particles in the first portion.

8. The injection-molded body according to claim 1,
wherein the ratio of the elastomer to the matrix resin in the area range of 10² μm² or more and 130² μm² or less in the second portion is 10% or more, and
wherein the ratio of the elastomer to the matrix resin in the area range of 10² μm² or more and 130² μm² or less in the first portion is less than 50%.

9. The injection-molded body according to claim 1,
wherein the ratio of the elastomer to the matrix resin in the area range of 10² μm² or more and 130² μm² or less in the second portion is 1.5 times or more the ratio of the elastomer to the matrix resin in the area range of 10² μm² or more and 130² μm² or less in the first portion.

10. The injection-molded body according to claim 1, wherein the ratio of the elastomer to the matrix resin in the area range of 10² μm² or more and 130² μm² or less in the first portion is an average value in the first portion.

11. The injection-molded body according to claim 1, wherein the ratio of the elastomer to the matrix resin in the area range of 10² μm² or more and 130² μm² or less in the second portion is a maximum value in the second portion.

12. The injection-molded body according to claim 1, wherein the first portion is in a region 250 μm or more away inside from the surface, and the second portion is in a region 50 μm or more and less than 500 μm away inside from the surface.

13. The injection-molded body according to claim 1, further comprising a third portion between the second portion and the surface,
wherein a ratio of the elastomer to the matrix resin in an area range of 10² μm² or more and 130² μm² or less in the third portion is lower than the ratio of the elastomer to the matrix resin in the area range of 10² μm² or more and 130² μm² or less in the first portion.

14. The injection-molded body according to claim 13, wherein the third portion is in a region less than 50 μm away inside from the surface.

15. The injection-molded body according to claim 1, wherein the matrix resin is polyester.

16. The injection-molded body according to claim 1, wherein the elastomer is an acrylic elastomer.

17. The injection-molded body according to claim 1, wherein a melting point of the elastomer is lower than a glass-transition point or a melting point of the matrix resin.

18. The injection-molded body according to claim 1, further comprising filler particles having an inorganic material dispersed in the matrix resin as a main component.

19. A device comprising:
a member composed of the injection-molded body according to claim 1; and
at least any of an electric component, a metal component, and an optical component.

20. The device according to claim 19, wherein the member is an exterior body.

21. A method for manufacturing an injection-molded body, comprising:
injection-molding a mixture of pellets of a first resin composition obtained by dispersing first elastomer particles in a matrix resin and pellets of a second resin composition obtained by dispersing second elastomer particles in the matrix resin,
wherein a difference between an average particle diameter of the first elastomer particles and an average particle diameter of the second elastomer particles is 0.8 μm or more.

22. The method for manufacturing an injection-molded body according to claim 21, wherein the average particle diameter of the first elastomer particles is twice or more the average particle diameter of the second elastomer particles.

23. The method for manufacturing an injection-molded body according to claim 21, wherein the average particle diameter of the first elastomer particles is 1.5 μm or more, and the average particle diameter of the second elastomer particles is less than 1.5 μm.

24. The method for manufacturing an injection-molded body according to claim 21, further comprising manufacturing the first resin composition,
wherein the manufacturing of the first resin composition is melting and kneading a matrix resin and an elastomer material and dispersing the first elastomer particles in the matrix resin.
